(19) United States
(12) Patent Application Publication
(10) Pub. No.: US 2011/0201307 A1
(43) Pub. Date: Aug. 18, 2011

(54) ACCESS CONTROL FOR M2M DEVICES

(75) Inventor: Louis SEGURA, Saint Laurent (CA)

(73) Assignee: TELEFONAKTIEBOLAGET L M ERICSSON (PUBL), Stockholm (SE)

(21) Appl. No.: 13/028,093

(22) Filed: Feb. 15, 2011

Related U.S. Application Data
(60) Provisional application No. 61/304,716, filed on Feb. 15, 2010.

(51) Int. Cl. G06F 21/20; G06F 15/16; H04M 1/66

(52) U.S. Cl. 455/411; 726/3

(57) ABSTRACT

A system for restricting Machine-to-Machine devices from accessing system resources in a 3GPP compliant network without adversely affecting the access of human operated devices makes use of a new network function that instructs all devices that are internally identified as M2M devices to block access. As such, M2M and H2H devices can be assigned to the same access classes, as presently required, but need not be access barred under the same circumstances.

### CROSS-REFERENCE TO RELATED APPLICATIONS

This application claims the right of priority to U.S. Provisional Patent Applicant No. 61/304,716 Filed Feb. 15, 2010, the contents of which are expressly incorporated herein by reference.

### TECHNICAL FIELD

This disclosure relates generally to access control for machine-to-machine communication devices.

### BACKGROUND

Access Class Barring (ACB) is a known operation in mobile networks, whereby devices of certain classes can be barred from using defined resources so that other devices can be provided priority.

At present, access class barring is geared towards distinguishing access control between a mobile assigned an access class for “normal” uniform access control treatment (0-9) and higher priority classes. These classes were defined when essentially all devices were used by human operators, and did not anticipate the rise of machine-to-machine (M2M) operation. Accordingly, the current specifications related to ACB mechanism lack mechanism to differentiate between M2M devices and human operated devices. As such, there is a lack of procedures that can be directed to sending messages and instructions exclusively to M2M devices.

As more devices, both human operated and M2M, are added to the network, the likelihood of congestion on the radio access channels increases. Many M2M devices are used for automated reporting of values to a centralized system, and through timely access is desired, it is often not so crucial that an M2M device cannot delay its access to a congested network. Meanwhile, human operators of network devices are more prone to being inconvenienced by congested networks that may require that their device be disconnected or even refused access temporarily. Without the ability to treat M2M devices differently than human operated devices, as loads on a network increase, an M2M device that does not need timely access to the network is treated the same as a human operated device. By providing a mechanism to differentiate M2M devices from other network devices the appearance of network congestion can be mitigated.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method for barring access in a mobile device network. The method comprises the steps of implementing an access barring function specifying a device type; receiving an access request from a terminal device in the mobile network; and processing the received access request in accordance with the implemented access barring function.

In an embodiment of the first aspect of the present invention, the device type is a Machine-to-Machine type device. In another embodiment of the present invention, the access barring function specifies at least one of a device access class in addition to the device type, and one of all signaling and data signaling that is barred for the specified device type. In another embodiment, the method includes the further step of terminating all active connections after implementing the access barring function. In further embodiment, the step of implementing the access barring function includes assembling an access barring command message specifying the barred device type, and optionally includes the step of transmitting the assembled command message to active devices on the mobile device network, where the access barring command message can be a System Information Block Type 2. In another embodiment, the step of processing the received access request further includes providing access to the terminal device if a device type associated with the terminal device does not match the device type specified by the access barring function. In a further embodiment, the access barring function explicitly specifies a device type. Alternatively, the implemented access barring function implicitly specifies the device type and is selected from a set of access barring functions in accordance with the device type.

In a second aspect of the present invention, there is provided a method of implementing an access barring command in a mobile device having a preconfigured device type connected to a network over a radio access network. The method comprises receiving an access barring command specifying a device type; and implementing the received access barring command in accordance with the preconfigured device type.

In an embodiment of the second aspect of the present invention, the step of implementing includes ignoring the received access barring command if the specified device type does not match the preconfigured device type. In another embodiment, the specified device type is a Machine-to-Machine type device.

In a third aspect of the present invention, there is provided a radio access network node for determining network access. The node comprises a memory, a radio access network interface and a processor. The memory stores access barring instructions. The radio access network interface receives access requests from mobile devices over a radio access channel, and transmits messages to mobile devices connected to the radio access channel. The processor creates access barring instructions specifying a barred device type in accordance with received access barring information, stores the created access barring instructions in the memory, and transmits an access barring command determined in accordance with the access barring instructions to a connected mobile device over the radio access network interface.

In an embodiment of the third aspect of the present invention, the processor processes the access requests received over the radio access network interface in accordance with the access barring instructions stored in the memory.

In a fourth aspect of the present invention, there is provided a mobile device for connecting to a radio access network and for implementing an access barring command. The device comprises a receiver and a processor. The receiver receives the access barring command specifying a device type, the command received over the radio access network. The processor processes the received access barring command in accordance with a preconfigured device type, and stores a set of access rules determined in accordance with the received access barring command in a memory.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention can be described, by way of example, with reference to the Figures, wherein;

FIG. 1 is a block diagram illustrating a mobile device of the present invention;

FIG. 2 is a representation of a SIBType2 message according to an embodiment of the present invention;

FIG. 3 is a flowchart illustrating an exemplary method of the present invention;

FIG. 4 is a flowchart illustrating an exemplary method of the present invention;

FIG. 5 is a flowchart illustrating an exemplary method of the present invention;

FIG. 6 is a flowchart illustrating an exemplary method of the present invention;

FIG. 7 is a flowchart illustrating an exemplary method of the present invention;

FIG. 8 is a flowchart illustrating an exemplary method of the present invention;

FIG. 9 is a block diagram illustrating an exemplary radio access network element of the present invention; and

FIG. 10 is a block diagram illustrating an exemplary mobile device of the present invention.

### DETAILED DESCRIPTION

The present invention is directed to a system and method for access control on a mobile network.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In the following discussion, a solution to the problems outlined above is provided. The method and system disclosed below allows broadcast of access class barring information to be used by M2M devices. Such a message can be used in a variety of different situations including an overloaded cell condition, which may caused through misbehaving/misconfiguration of M2M devices or simply through excessive use of the radio access network. This provides the network operator the capability to independently bar M2M (machine-to-machine) and H2H (human-to-human) devices with different probability factors and barring times providing the means to bar possibly lower priority M2M devices while not necessarily having to restrict Random Access Channel (RACH) access to “normal” H2H oriented devices.

The extension of the Access Class Barring (ACB) functions, to specifically address a type of device instead of just a random class, can provide greater flexibility to the operator in restricting access to M2M devices in overload situations. In embodiments discussed below, a special category of M2M devices can also be implemented such that members of this class are not necessarily be barred in high load situations and can potentially take priority over H2H communications.

Those skilled in the art will appreciate that in discussions of Access Class Barring, the following points are understood:
Under certain circumstances, it may be desirable to prevent users of user equipment UE from making access attempts.
Broadcast messages are preferably available on a cell by cell basis indicating the class(es) of subscribers barred from network access.
The use of an ACB facility allows the network operator to prevent overload of the access channel under critical conditions.
Access control functions are typically not used under normal operating conditions.

In conventional mobile networks, each piece of User Equipment (UE) is a member of one of ten randomly allocated mobile populations, defined as Access Classes 0 to 9. The population number is stored in the SIM/USIM. In addition, mobile devices may be members of one or more out of 5 special categories (Access Classes 11 to 15), also identified by configuration data in the SIM/USIM. These are allocated to specific high priority users as follows. (The enumeration is not meant as a priority sequence):

| | |
|---|---|
| Class 15 | PLMN Staff |
| Class 14 | Emergency Services |
| Class 13 | Public Utilities |
| | (e.g. Water/Gas suppliers) |
| Class 12 | Security Services |
| Class 11 | Reserved for PLMN use |

In conventional implementations, UEs dedicated to performing M2M functions are assigned to the existing classes 0-9 which are shared with H2H devices. As a result, there is no convenient mechanism through which the operator to selectively bar M2M devices from accessing the RACH. Adding a new class would involve creating incompatibilities in a number of network services, and as a result is not considered to be a reasonable solution. Similarly, none of classes 0-9 can be set aside now as there are many H2H devices in each of these classes.

Current specifications for mobile networks allow for Selective Access Class Barring. A broadcast messages, such as Ac-BarringForSpecialAC bitmap in SIB2, informs devices in at least one of Access Classes 11-15 that they can ignore cell barring. This allows higher priority devices to maintain their access (or start new access) to the RACH. “Normal” devices (non access class 11-15) can be barred with a certain probability using ac-Barringfactor and ac-BarringTime type messages along with a random factor to determine the resulting barring time. This allows normal (human-to-human) and M2M devices to be barred in conventional networks, which lowers the load on the RACH channel thereby allowing priority users to be exempt from suffering congestion when accessing the RACH.

As more M2M devices are added to the network, they will be randomly assigned membership in one of classes 0-9, as well as being assigned a higher class as needed (e.g. AC12 for an M2M device providing special security service, or AC 14 for devices that generate emergency calls). As a result, it is not possible in conventional networks to selectively bar lower priority M2M without also barring “normal” devices (and impacting H2H communication).

Lower priority M2M devices could include a typical massive deployment of M2M devices which must periodically report data to an server but for which exact reporting time is not critical (i.e. time sensitive) and in particular can be delayed in an overload situation. One example of such a device is a so-called smart-meter used for monitoring electrical usage. A delay in the reporting from such a device has at most a negligible impact. In addition given the flexibility that is envisioned for programming/configuration of M2M devices there is a real risk that a faulty configuration in the large set of M2M devices (e.g. millions of smart utility meters) could result in RACH overload due to exclusive and simultaneous access by M2M devices. To address this, all members of the class to which the devices have been assigned would likely be barred from accessing the network until the problem was resolved. This could result in the appearance of a large system failure for human operated devices.

Mechanisms of the present invention replicate and extend access control exclusively for M2M based on existing H2H based mechanisms. An M2M device is assigned internal configuration setting that can indicate that it is an M2M device, and is then, as before, randomly allocated an access class (0-9) and potentially additional higher access classes (11-15). A solution modeled on access control as per TS 36.331 (chapter 5.3.3.2) that replicates access barring information but adds broadcast information to be used exclusively by “M2M” devices can then be implemented. Presently the SystemInformationBlockType2 contains ac-BarringInfo and the ac-BarringForMO-Data and Signaling. New additions to the Block Type in the present invention include elements directed at M2M devices (optionally named): ac-BarringforMO-M2MData and ac-BarringforMO-M2MSignalling

The solution allows EUTRAN (i.e. eNodeB) to broadcast different access class barring info for “H2H” and “M2M” devices operating in the cell. One skilled in the art will appreciate that a similar solution can be provided for differing radio access networks, and it is anticipated that this solution can be used in Long Term Evolution (LTE) network, as well as in High Speed Packet Access (HSPA), GSM EDGE Radio Access Network (GERAN) and other networks including cdma2000, EVDO, WiMax and other such wireless cellular based networks.

By broadcasting to all devices, and specifying one of the newly proposed messages, all devices that have been designed to identify themselves as M2M devices will take themselves off line. This provides network operators the ability to bar “M2M” devices without barring “H2H” devices. Furthermore, it allows M2M and H2M to be independently barred with different probability factors and barring times. Devices with special AC 11-15 can bypass access class barring through presence of “ac-BarringFor SpecialAC” contained in either new IE (e.g. ac-BarringforMO-M2MData or ac-BarringforMO-M2MSignalling). Those skilled in the art will appreciate that providing the same functionality using different function names is considered to be well within the scope of the present invention. H2H devices need not be designed to recognize this command, and as such they will not detach from the network.

In summary, such a mechanism proves network operators with the ability to bar “M2M” devices without barring “H2H” devices. This allows simultaneous and independent control of the access given to M2M and H2H devices using different probability factors and barring times. Network operators retain the ability to allow access to M2M devices assigned special AC 11-15 to bypass access class barring through presence of “ac-BarringFor SpecialAC” contained in either new IE (e.g. ac-BarringforMO-M2MData or ac-BarringforMO-M2MSignalling). This introduces and allows a new category of automated M2M devices such as for security, emergency purposes and utility (e.g. M2M telemetry alarm from Nuclear power plant) that can access the network in overload situations. With these abilities, problems associated with network usage by errantly programmed M2M devices in large scale deployments of M2M will not necessarily adversely impact H2H devices by limiting RACH capacity and or network capacity

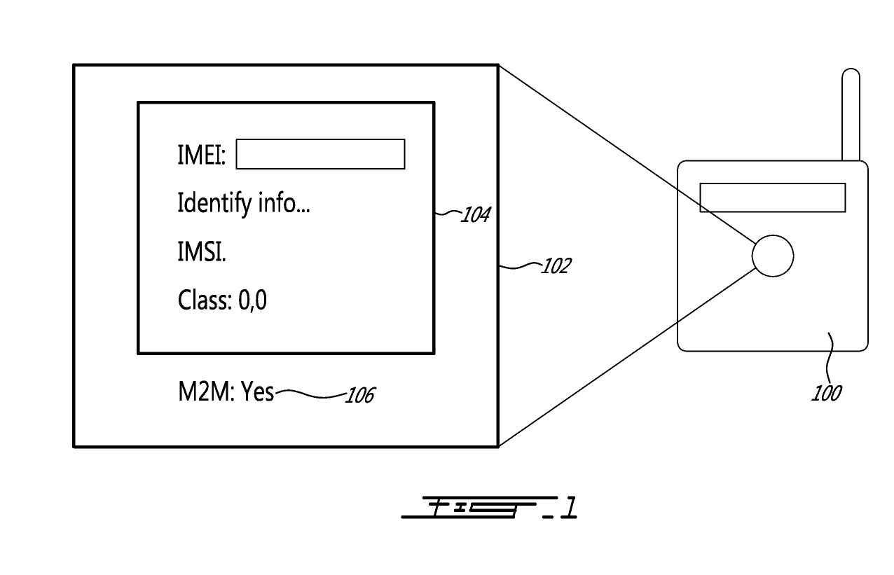

The above described solution will now be discussed in more details with respect to embodiments illustrated in the Figures. FIG. 1 illustrates a machine to machine device 100 of the present invention. Device 100 has a configuration 102 which includes conventional configuration information 104 including an IMEI, and at least one access class. Additionally a M2M configuration value 106 is included that allows the device to identify itself as a M2M device. It will be understood that in place of, or in addition to, a configuration value specifying that a device is an M2M device, this information can instead by provided to the device by instructing it how to process and respond to a command directed solely at M2M devices.

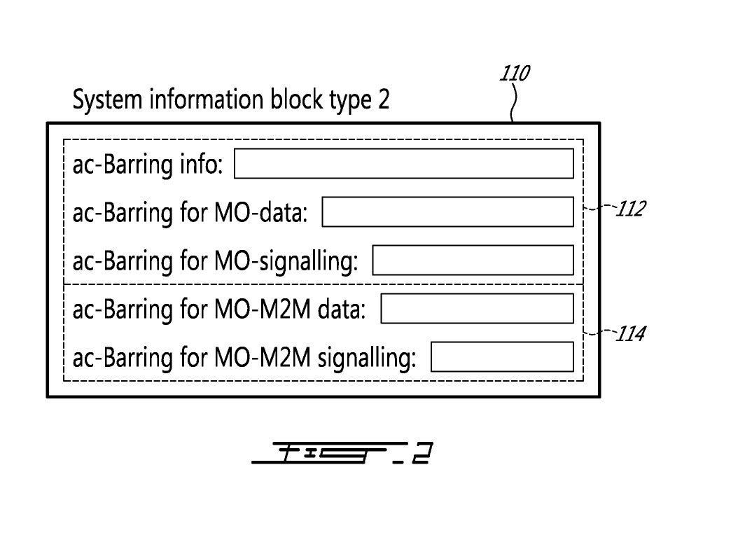

When a particular cell is overloaded, a System Information Block Type 2 (SIB Type 2) message is transmitted. FIG. 2 illustrates a SIB Type 2 message 110 according to an embodiment of the present invention. In addition to conventional information 112 such a the ac-Barring Info, the ac-Barring for MO-data and ac-Barring for MO-signaling values (and other such messaging fields), the new SIB Type 2 message 110 includes new access class barring values 114 that are specific to M2M devices. In the illustrated embodiment, the new ac barring values 114 include “ac-BarringForMO-M2Mdata” and “ac-BarringForMO-M2Msignaling”. One skilled in the art will appreciate that the specific naming of these fields is not crucial. The names of these parts of the new SIBType2 message can be varied without departing from the scope of the present invention.

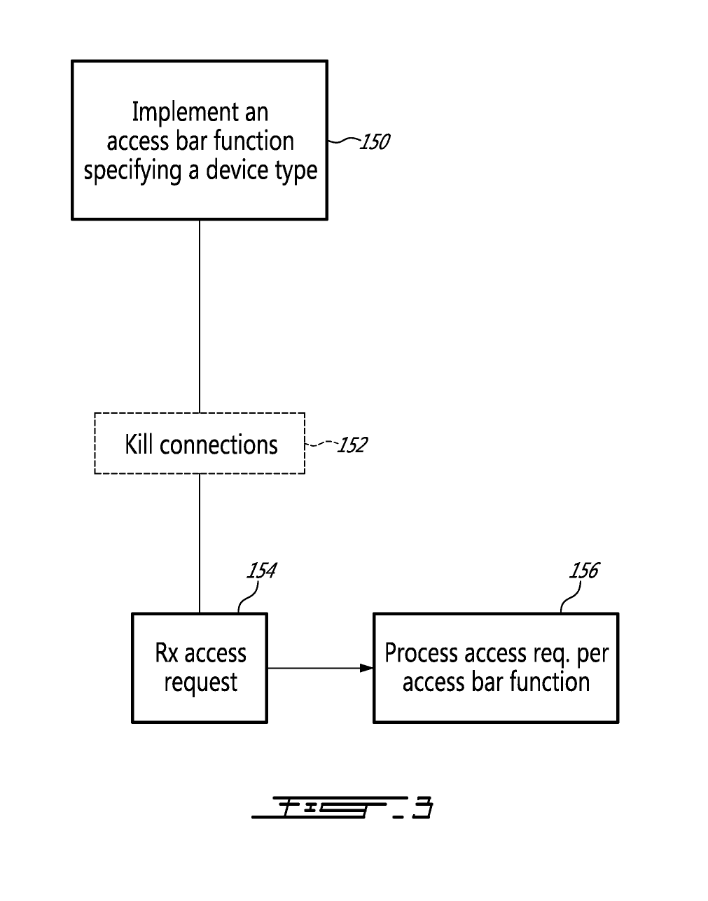

FIG. 3 is a flowchart illustrating a method of the present invention executed by a network infrastructure element such as a radio access base station. In step 150, a decision is taken in the network base station to implement an Access Bar function that specifies a device type. This message can specify whether it applies to all devices in the type or just particular classes, the message can also specify whether it relates to all signaling or just data access, it can set bypass condition, and it can also deactivate all connection immediately. In optional step 152, all connections over the radio channel can be disconnected if so required. In step 154, the base station receives an access request and in step 154 process the access request in accordance with the access bar function that specifies a device type that was implemented in step 150. Those skilled in the art will appreciate that the specification of a device type in step 150 can be achieved by either specifying the device type in a message, or by using a message that will only be processed by devices of the desired type.

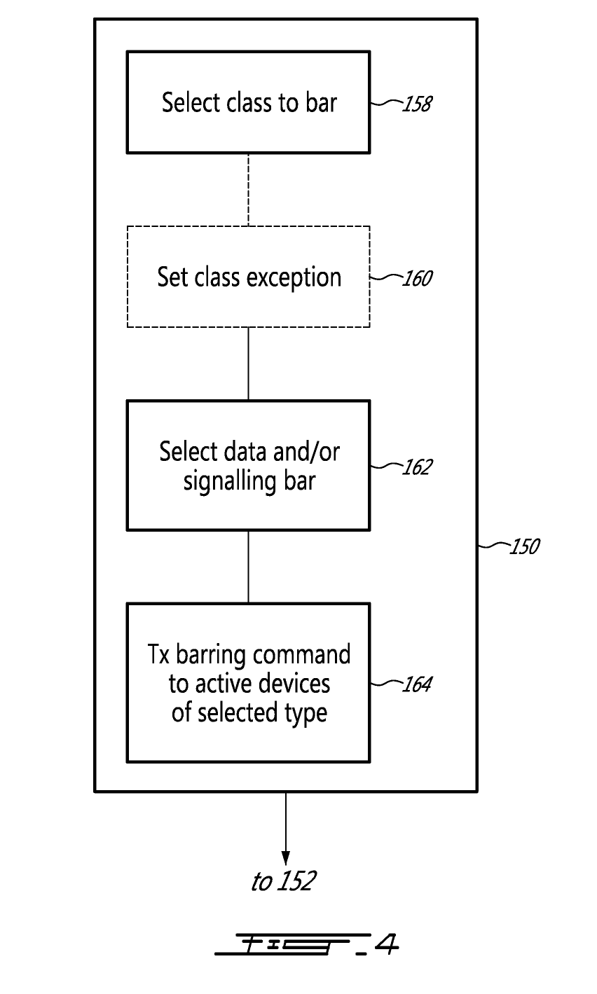

FIG. 4 illustrates an embodiment of step 150 of FIG. 3 in more detail. In step 158, a class that will be barred is selected. It should be noted that in this embodiment, the device type for barring has already been selected. If necessary a class exception is specified in step 160, and whether it is data or all signaling that is barred is selected in step 162. In step 164, the barring command is transmitted to active devices of the already selected type, and the process continues to step 152.

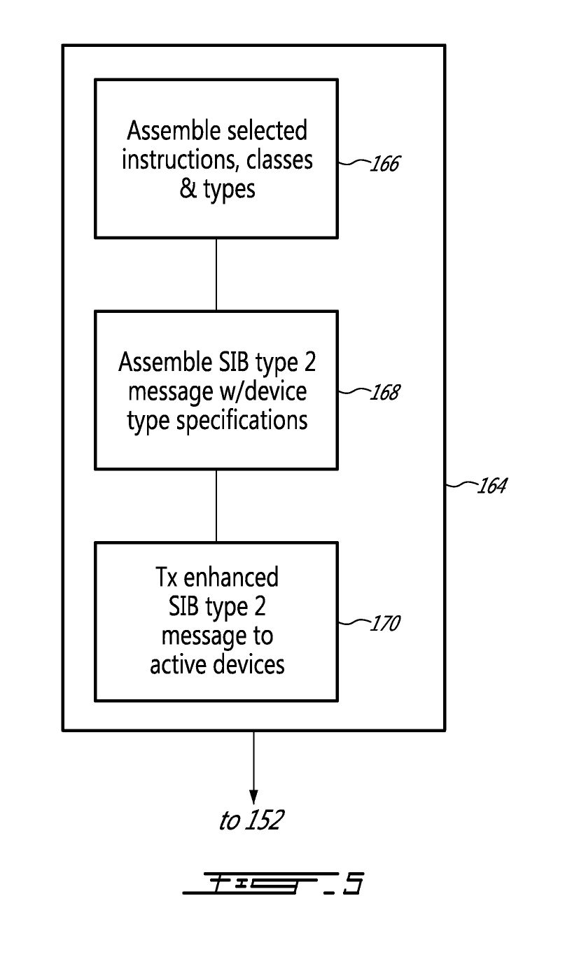

FIG. 5 illustrates a particular embodiment of step 164 in FIG. 4. In step 166, the selected instructions, classes and types are assembled. In step 168, a SIBType2 message is assembled using the device type specifications assembled in step 166. In step 170, the enhanced SIBType2 message is transmitted to active devices and the process continues to step 152.

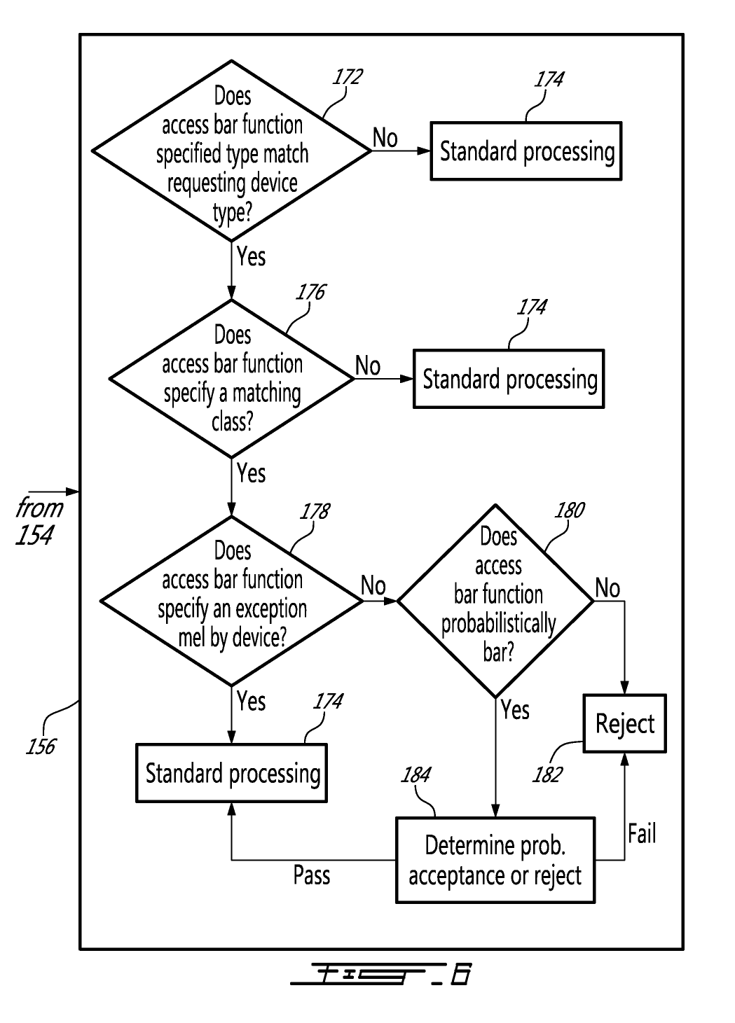

FIG. 6 is a flowchart illustrating a method of carrying out step 156 of FIG. 3 according to an embodiment of the present invention. In step 172 a determination is made as to whether the device type specified in the Access Bar function of step 150 matches the requesting device type. If there is no match, standard processing is followed in step 174. If there is a match, a determination is made in step 176 as to whether the Access Bar Function specifies a matching class to the requesting device. If no class match is found in step 176, standard processing occurs in step 174, otherwise the process continues to step 178. In step 178, a determination is made if the access Bar function specifies another exception that is met by the device. If such a match occurs, standard access processing in step 174 is undertaken. However, if no such match occurs, a determination is made in step 180 as to whether the Access Bar function operates probabilistically. If the access barring function is not probabilistic, the connection is rejected in step 182. If the access barring function is probabilistic, a probabilistic test is executed in step 184. If the test is passed, then standard access processing is undertaken in step 174, while if the test is failed, the connection is rejected in step 182.

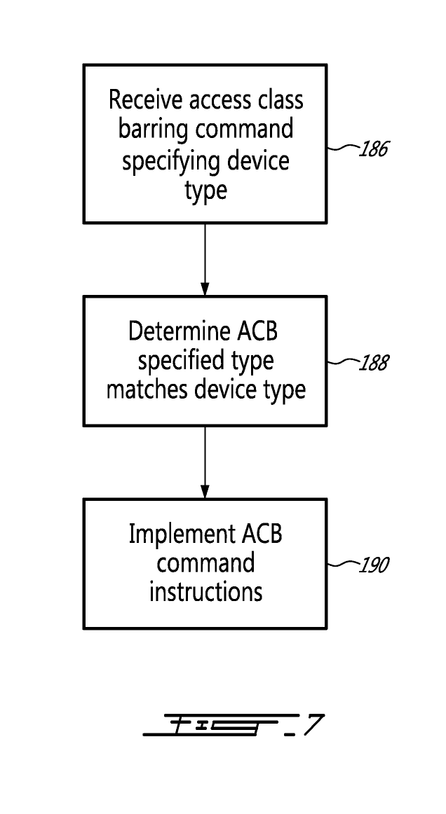

FIG. 7 illustrates a method of the present invention that can be executed on a device that access a network through a radio access channel, such as a M2M device. In step 186, an Access Class Barring Command specifying a device type is received. In step 188, a determination of whether the Access Class Barring Command type matches the device type is undertaken. In step 190, the Access Class Barring Command instructions are implemented as applicable.

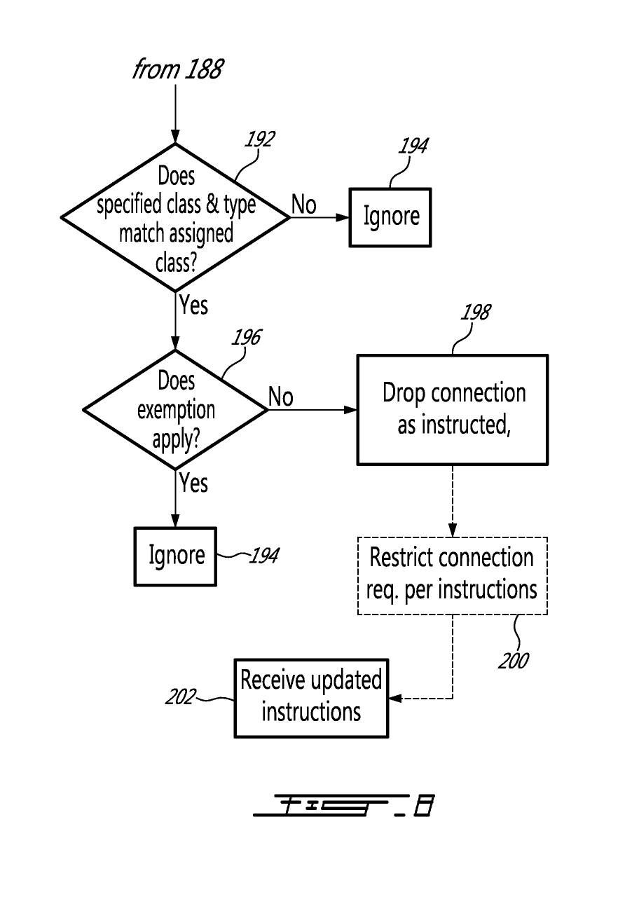

FIG. 8 illustrates an exemplary embodiment of a method of carrying out step 190 of FIG. 7. In step 192 a determination is made if the specified class and type match the assigned class and type of the device. If there is no such match the ACB message is ignored in step 194. If there is a match, a determination is made in step 196 if the ACB message includes any exemptions that apply. If such exemptions apply, the ACB message is ignored in step 194. If no such exemptions apply, the connection is terminated as instructed in step 198. The connection may be terminated either immediately or after a delay, and such a delay can be specified in the ACB message. In step 200, the device can optionally restrict connection requests as specified in the ACB message. In step 202, the device receives updated instructions and then can act accordingly.

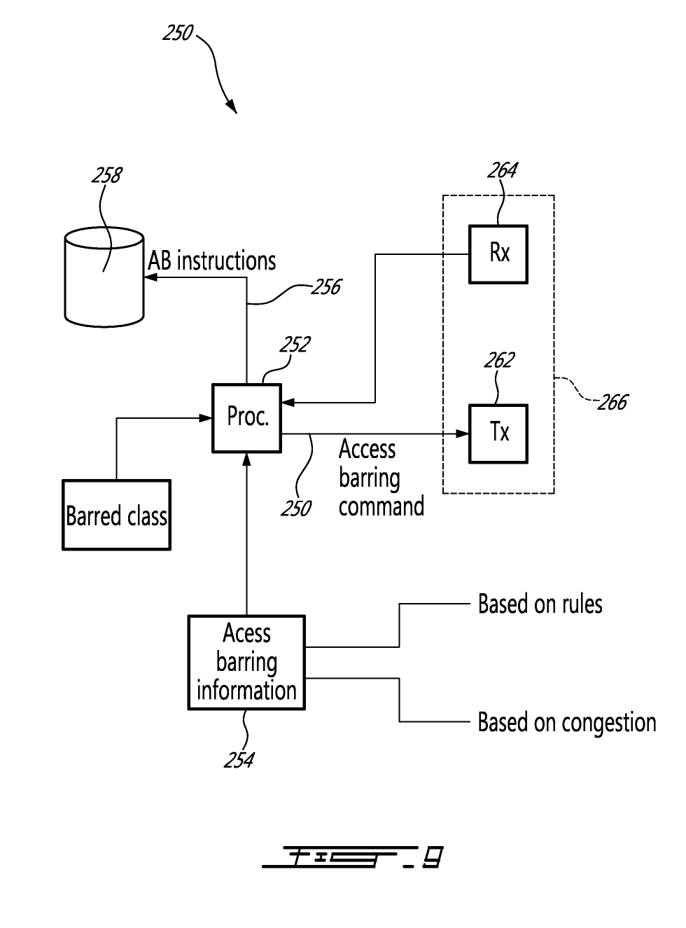

FIG. 9 illustrates an exemplary radio access network element 250 of the present invention. Device 250 includes a processor 252 which receives access barring information 254, such information may include barring information based on congestion and/or rules. Those skilled in the art will appreciate that an operator can also trigger such an event for a variety of other reasons (such as maintenance or other operation needs) The access barring information 254 and barred classes, which can be selected at random, are used by processor 252 to generate Access Barring (AB) instructions 256, which are stored in database 258, and preferably specify a device type to which they apply. Based on the AB instructions 256, processor 252 can generate an Access Barring Command 260 that specifies a device type and which is sent to the radio access channel interface 266. Radio access channel interface 266 can include a functional transmitter 262 and receiver 264, the implementation of which will be well understood by those skilled in the art. The access barring command 250 can be relayed to a plurality of devices over the radio access channel. Over receiver 264, device 250 can receive requests for access, that are processed in accordance with the stored Access Barring instructions using methods such as those described earlier.

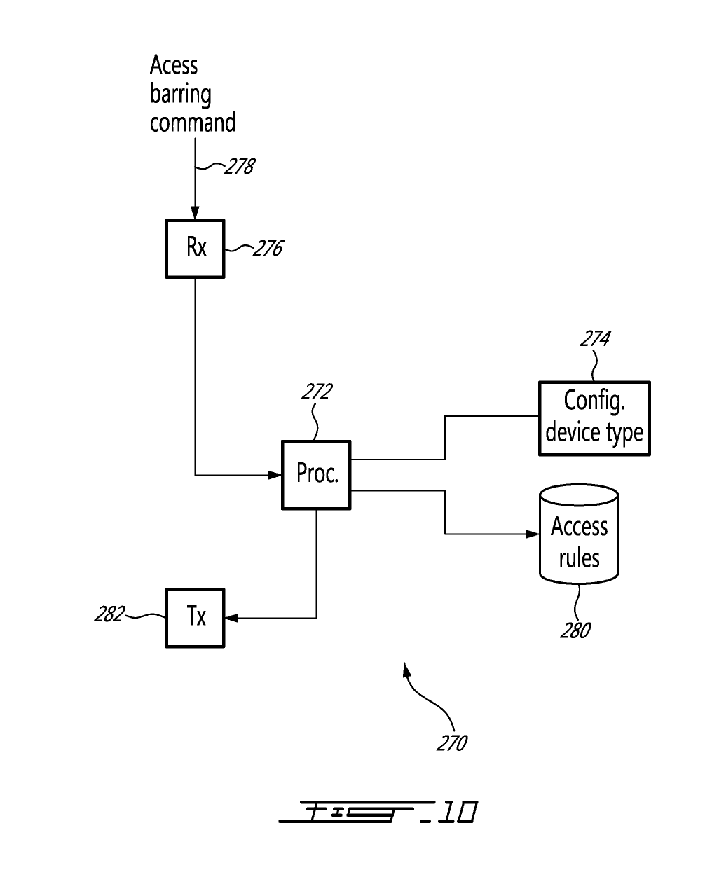

FIG. 10 illustrates a mobile access device 270, such as M2M device of the present invention. Device 270 includes processor 272, which has access a stored configuration that includes a specified device type. Receive 278 and transmitter 282 make up the radio access channel interface, and device 270 can receive an Access Barring Command 278 from the radio access network through receiver 276. When an Access Barring Command 278 is received by receiver 276, it is processed by processor 272. If the Access Barring Command 278 is determined to apply to both the device type and class associated with device 270, a new set of access rules 280 can be stored in a memory 280 and used to determine how access attempts are made to the network. It will be understood that processor 272 can determine if the access barring command 278 applies to the device through the use of a method such as those discussed above.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for barring access in a mobile device network, the method comprising:
implementing an access barring function specifying a device type;
receiving an access request from a terminal device in the mobile network; and
processing the received access request in accordance with the implemented access barring function.

2. The method of claim 1 wherein the device type is a Machine-to-Machine type device.

3. The method of claim 1 wherein the access barring function specifies a device access class in addition to the device type.

4. The method of claim 1 wherein the access barring function specifies one of all signaling and data signaling that is barred for the specified device type.

5. The method of claim 1 further including the step of terminating all active connections after implementing the access barring function.

6. The method of claim 1 wherein the step of implementing the access barring function includes assembling an access barring command message specifying the barred device type.

7. The method of claim 6 further including the step of transmitting the assembled command message to active devices on the mobile device network.

8. The method of claim 6 wherein the access barring command message is a System Information Block Type 2.

9. The method of claim 1 wherein the step of processing the received access request further includes providing access to the terminal device if a device type associated with the terminal device does not match the device type specified by the access barring function.

10. The method of claim 1 wherein the access barring function explicitly specifies a device type.

11. The method of claim 1 wherein the implemented access barring function implicitly specifies the device type and is selected from a set of access barring functions in accordance with the device type.

12. A method of implementing an access barring command in a mobile device having a preconfigured device type connected to a network over a radio access network, the method comprising:
receiving an access barring command specifying a device type; and
implementing the received access barring command in accordance with the preconfigured device type.

13. The method of claim 12 wherein the step of implementing includes ignoring the received access barring command if the specified device type does not match the preconfigured device type.

14. The method of claim 12 wherein the specified device type is a Machine-to-Machine type device.

15. A radio access network node for determining network access, the node comprising:
a memory for storing access barring instructions;
a radio access network interface for receiving access requests from mobile devices over a radio access channel, and for transmitting messages to mobile devices connected to the radio access channel; and
a processor for creating access barring instructions specifying a barred device type in accordance with received access barring information, for storing the created access barring instructions in the memory, and for transmitting an access barring command determined in accordance with the access barring instructions to a connected mobile device over the radio access network interface.

16. The node of claim 15 wherein the processor processes the access requests received over the radio access network interface in accordance with the access barring instructions stored in the memory.

17. A mobile device for connecting to a radio access network and for implementing an access barring command, the device comprising:
a receiver for receiving the access barring command specifying a device type, the command received over the radio access network; and
a processor for processing the received access barring command in accordance with a preconfigured device type, and for storing a set of access rules determined in accordance with the received access barring command in a memory.
